(19) United States
(12) Patent Application Publication
(10) Pub. No.: US 2019/0084574 A1
(43) Pub. Date: Mar. 21, 2019

(54) Digital Clutch Gauge

(71) Applicant: PARAM HANS SETH, Charlotte, NC (US)

(72) Inventor: PARAM HANS SETH, Charlotte, NC (US)

(21) Appl. No.: 15/663,792

(22) Filed: Sep. 12, 2017

(51) Int. Cl. B60W 30/19; B60K 35/00; B60K 37/02

(52) U.S. Cl. CPC B60W 30/19; B60K 35/00; B60K 2350/108; B60K 2350/1064; B60K 37/02

(57) ABSTRACT

A digital display type similar to a tachometer or fuel gauge for an automobile for numerically displaying the “optimal shift point.” The will serve several purposes. This will allow less wear and tear on the clutch, elongate the life of the clutch, prevent it from burning out as quickly it would reducing overall cost in the long run and providing a smoother, safer ride.

### FIELD OF INVENTION

The “Digital Clutch Gauge” suggested belongs to the areas of electronics, general application mechanics and especially to the automobile industry.

### ABSTRACT

A digital display type similar to a tachometer or fuel gauge for an automobile for numerically displaying the “optimal shift point” The will serve several purposes. This will allow less wear and tear on the clutch, elongate the life of the clutch, prevent it from burning out as quickly it would reducing overall cost in the long run and providing a smoother, safer ride.

### BACKGROUND OF THE INVENTION

A manual transmission, also known as a manual gearbox, stick shift, or a stick for vehicles with hand-lever shifters, is a type of transmission used in motor vehicles. It uses a driver-operated clutch engaged and disengaged by a foot pedal for regulating torque transfer from the engine to the transmission. If your car has a manual gearbox, your car will have a clutch. A clutch is particularly susceptible to wear, especially if it is not used properly.

One of the key points to minimize wear to the clutch is to know where the ‘optimal shifting point’ of the clutch is. This is the point where the clutch plates meet. The point when the car starts to move when you slowly get off the clutch pedal after having depressed it. When shifting, most clutch wear comes from the “friction zone,” that is, the space between the clutch being fully depressed and fully out. If the clutch has reached its ‘optimal shifting point’, it is important that the clutch pedal be released as to not inflict unnecessary wear upon it through clutch slippage. Each manufacturer has slight differences in their clutch assembly, so I have laid out the general outline of how the typical clutch assembly works (see Figure below)

A clutch assembly consists of three main components. A pressure plate, flywheel & clutch plate (see Figure below). In a manual transmission, the flywheel is attached to the engine's crankshaft and spins along with it. The clutch disk is in between the pressure plate and the flywheel, and is held against the flywheel under pressure from the pressure plate. When the engine is running and the clutch is engaged (clutch pedal is in the up position), the flywheel spins the clutch plate and hence the transmission.

In all vehicles using a transmission a coupling device is used to separate the engine and transmission when necessary. This is because an internal-combustion engine must continue to run when in use. The clutch accomplishes this in manual transmissions.

As the clutch pedal is depressed, the throw out bearing is activated, which causes the pressure plate to stop applying pressure to the clutch disk. This makes the clutch plate stop receiving power from the engine, so that the gear can be shifted without damaging the transmission. When the clutch pedal is released, the throw out bearing is deactivated, and the clutch disk is again held against the flywheel, allowing it to start receiving power from the engine.

Between the extreme of a of clutch pedal being fully depressed (where no torque is transferred from the engine to the transmission) and a clutch being fully released (where all of the engine's torque is transferred), the clutch slips to varying degrees (Slippage) When slipping it still transmits torque despite the difference in speeds between the engine crankshaft and the transmission input. Because this torque is transmitted by means of friction rather than direct mechanical contact, considerable power is wasted as heat.

Because clutches use changes in friction to modulate the transfer of torque between engine and transmission, they are subject to wear in everyday use. The service life of the clutch depends on the operating conditions that it is subjected to. A very good clutch, when used by an expert driver, can last hundreds of thousands of miles (kilometers). Weak clutches, abrupt downshifting, inexperienced drivers, aggressive driving and other bad driving habits such as ‘riding the clutch’ or performing ‘burnouts, especially incorrectly can lead to more frequent repair or clutch replacement. Learning to use the clutch efficiently requires the development of muscle memory and a level of coordination.

Additionally, if an inexperienced driver selects an inappropriate gear by mistake, damage to mechanical components may occur. For most people, there is a slight learning curve when learning to drive a vehicle with a manual transmission since the ‘optimal shift point’ is different on every vehicle. One of the purposes of the Digital Clutch Gauge is to shorten that learning curve. Because the driver must develop a feel for properly engaging the clutch, he/she may use the DCG as a tool in perfecting their shifting practices

### SUMMARY OF THE INVENTION

As stated above, whenever a driver uses the clutch, the contact with the pressure plate causes a small amount of deterioration and wear. When the clutch is used properly, this is just part of the normal wear and tear that comes with driving any vehicle. When the driver presses down the clutch and does not change gears, however, the wear on the pressure plate is unnecessary and leads to the clutch burning out and needing replacement. Drivers who keep their foot on the clutch while the car is idling burn it out unnecessarily, as do those who use the clutch rather than the foot brakes or emergency brake to keep the car in one place while the car is idling on a hill.

Accordingly, the object of the invention is to provide a digital display type tachometer for a vehicle in which will assist the driver in making the smoothest shift possible and hitting the ‘optimal shift point’ as much as possible.

The optimal shifting point is the point where the least amount of friction and heat is dissipated. A gauge will be placed on the dashboard which will give readout (see drawings). A 0.0 reading on the gauge will represent a ‘perfect shift’ and that the ‘optimal shifting point’ was hit.

A 0.0 reading will represent minimum wear and tear and ensure that burn on the clutch is kept to a minimum. A 0.0 reading will also provide the smoothest and safest possible ride.

A reading of plus (+) or minus (−) will represent a deviation from the ‘optimal shift point’ depending on which direction the driver has shifted whether it be towards the clutch or the gas.

How it Works:

While performing research for this patent, I noticed that each manufacturer has slight differences in their clutch assembly so I will leave the details to the manufacturer.

Sensors will need to be placed on the flywheel, clutch & pressure plate. The sensors will measure the ‘gap’ or ‘slippage’ in between the plates and send a readout to the gauge on the dashboard. There are various options for which units the readout can display in. I recommend the distance in ‘the gap’ be reported in millimeters (and give the option of micrometers and nanometers). Another option is to give a readout of temperature in degrees Celsius/Fahrenheit because as the amount of friction increases, so the amount of heat dissipated.

The best thing to do would be to give the as many options as possible and let the driver select what they like best as all drivers have different preferences. Same way as many cars let you change a digital speedometer between MPH and KPH.

Every time a new ‘gap’ in the clutch is experienced while shifting, a new readout will be displayed.

Gauges in come in many shapes and sizes. I will leave the aesthetics up to the manufacturer. I have laid out a few different options in figures below. Storing this information for analysis for later use downloaded to handhelds is another option.

There are several benefits of the DCG and why it is needed.
DCG will allow drivers to assess where they need to make changes in their coordination of their feet and balancing of the gas and clutch
Elongate the life of the clutch, reducing maintenance and repair costs in the long run
Provide a smoother and most importantly safer ride

The DCG is similar to many of the instruments on a plane that a pilot would use when flying. The pilot can their instincts, but still refer to their gauges from time to time.

What is being claimed here is a gauge measuring that distance between the plates where the least amount of friction and heat is produced along with the actual process or method of identifying the level of ‘clutch slippage’. That information is then converted to a digital readout to assist the driver in perfecting their shifting practices.

Further additions or applications to the invention would be to add a sensor to determine the remaining life in a clutch. Similar to how current digital fuel gauges will show how many miles the vehicle will be able to travel before running out of fuel.

Statistics:

Stick Shift vehicles on the road have decreased in recent years, from 35 percent of all vehicles in 1985 to about 10 percent today according to recent media reports. They are still the preference of millions of drivers in the U.S. as well as all over the world. Over 75% of vehicles made in Western Europe are equipped with manual transmission, versus 16.1% with automatic and 8.7% with other.

Although other types of transmission s exist, there will always be a market for stick shift vehicles. Many sports cars enthusiasts actually prefer the manual stick shift over some of the newer options that are available such as paddle shifters.

### BRIEF DESCRIPTION OF THE DRAWINGS

I have laid out four different samples of possible gauge designs in the figure below. This will be left up to the manufacturer as far as what type of gauge they wish to use.

### DETAILED DESCRIPTION OF THE PREFERRED EMBODIMENT

Each Figure has a description written next to it explaining the drawing

### SPECIFICATIONS

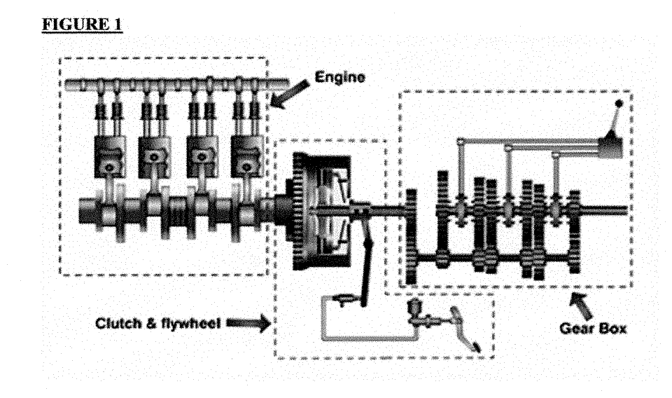

FIG. 1: Diagram showing clutch & flywheel, engine & gear box

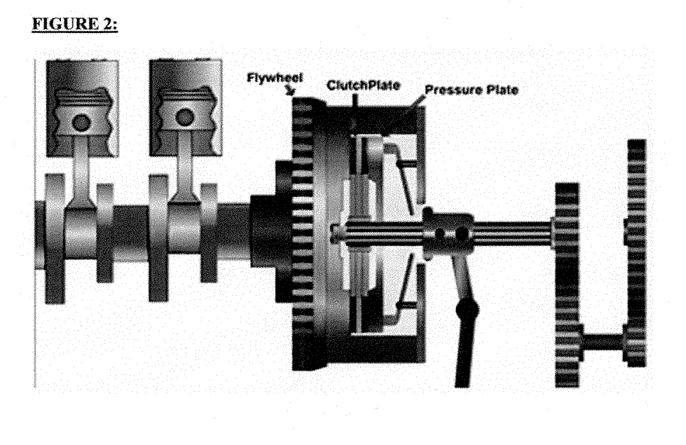

FIG. 2: Diagram showing flywheel, clutch plate & pressure plate

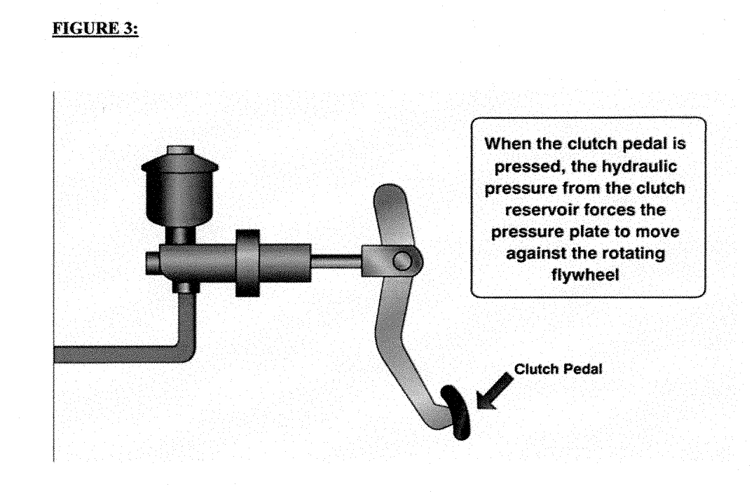

FIG. 3: Diagram showing what happens when a clutch pedal is pressed

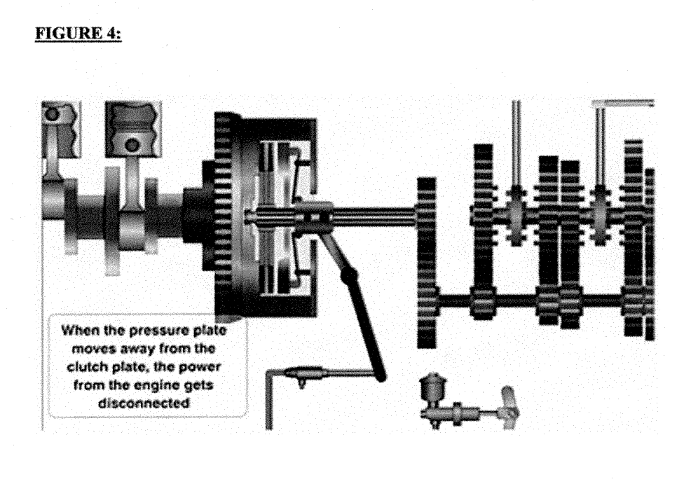

FIG. 4: Diagram showing pressure plate moving away from the clutch plate and the power from the engine getting disconnected

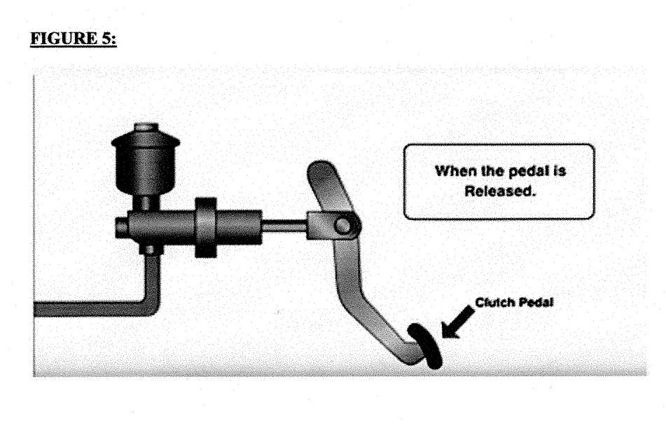

FIG. 5: Diagram of clutch pedal assembly

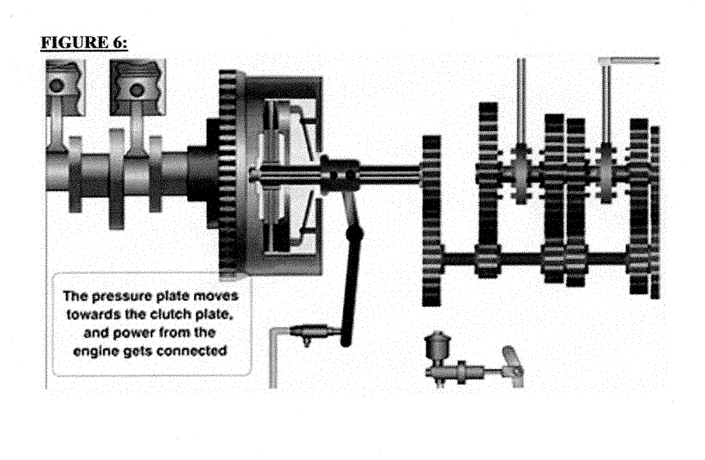

FIG. 6: Diagram showing pressure plate moving towards the clutch plate and the power from the engine getting connected

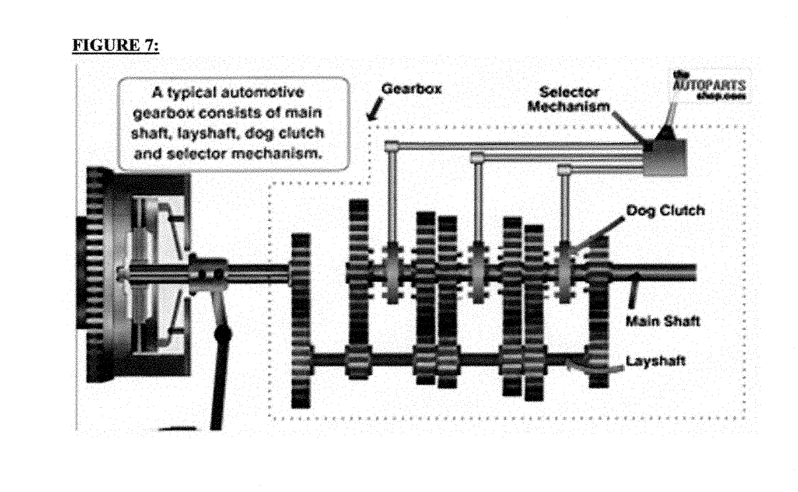

FIG. 7: Diagram showing components of the clutch assembly

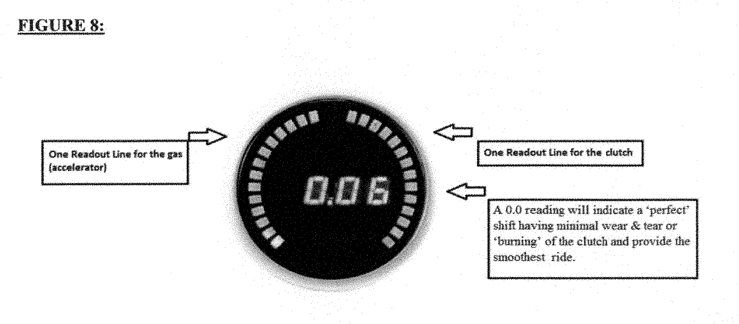

FIG. 8: Diagram showing a possible design option for the gauge

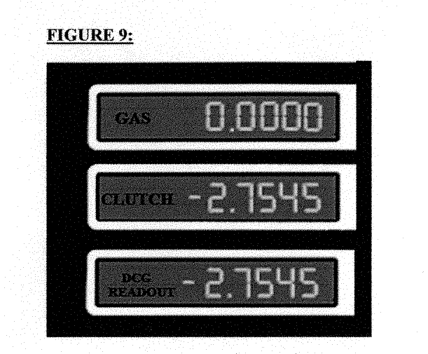

FIG. 9: Diagram showing a possible design option for the gauge

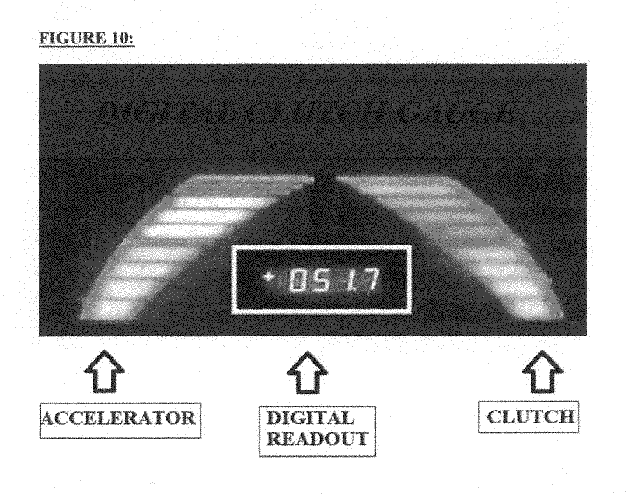

FIG. 10: Diagram showing a possible design option for the gauge

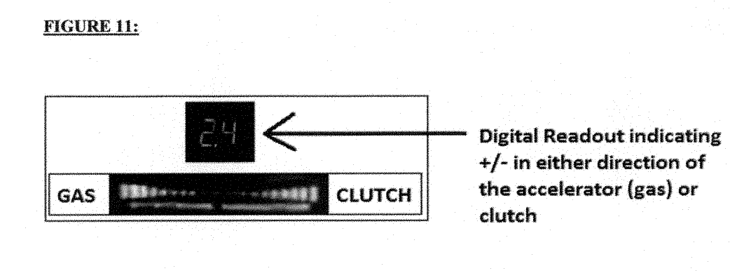

FIG. 11: Diagram showing a possible design option for the gauge

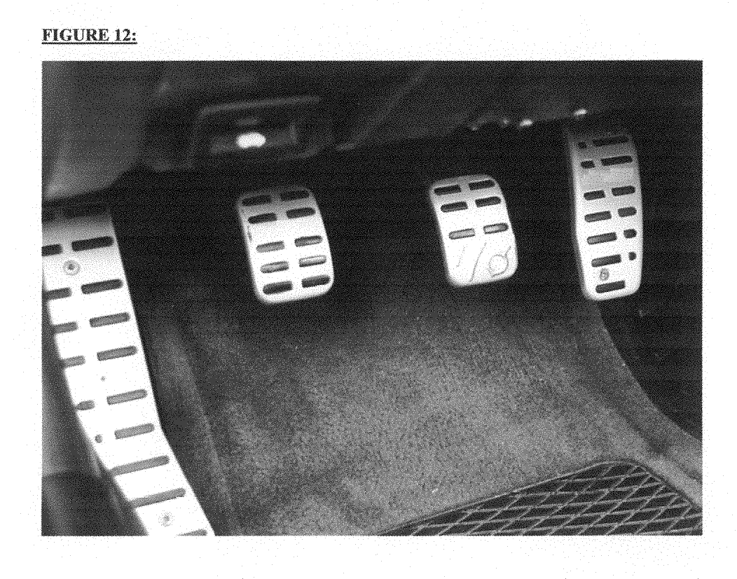

FIG. 12: Diagram showing Standard Layout of Accelerator, Brake & Clutch

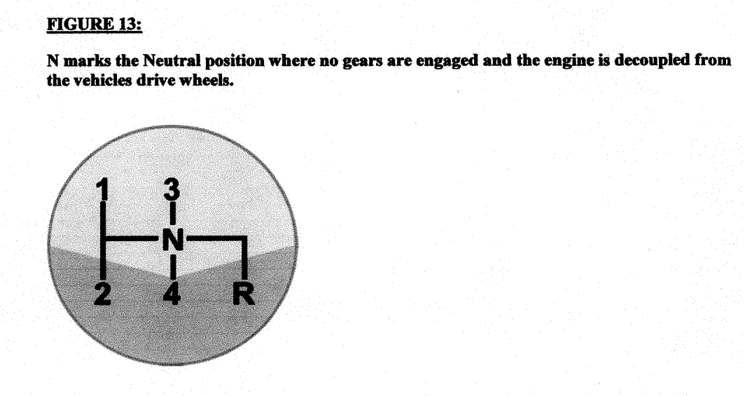

FIG. 13: Diagram showing Standard Layout of Gear Shifter

1. What is being claimed here is a gauge measuring that distance between the plates where the least amount of friction and heat is produced along with the actual process or method of identifying the level of ‘clutch slippage’. That information is then converted to a digital readout to assist the driver in perfecting their shifting practices.
